(19) United States
(12) Patent Application Publication
(10) Pub. No.: US 2020/0173287 A1
(43) Pub. Date: Jun. 4, 2020

(54) FUNCTIONAL STRUCTURE, ASSOCIATED COMPONENT FOR A TURBOMACHINE AND TURBINE

(71) Applicant: Siemens Aktiengesellschaft, Munich (DE)

(72) Inventors: Robin Blank, Berlin (DE); Lena Farahbod-Sternahl, Hannover (DE); Christoph Kiener, München (DE); Sascha Martin Kyeck, Berlin (DE); Yves Küsters, Berlin (DE); Simon Purschke, Berlin (DE); Helge Reymann, Berlin (DE)

(73) Assignee: Siemens Aktiengesellschaft, Munich (DE)

(21) Appl. No.: 16/634,587

(22) PCT Filed: Aug. 7, 2018
(86) PCT No.: PCT/EP2018/071334

§ 371 Date: Jan. 28, 2020

(30) Foreign Application Priority Data
Aug. 11, 2017 (DE) 10 2017 214 060.7

(51) Int. Cl. F01D 5/16; B22F 3/105

(52) U.S. Cl. CPC F01D 5/16; B33Y 10/00; B22F 3/1055

(57) ABSTRACT

A functional structure for use in an energy converter and/or a turbomachine. The structure includes a lattice with at least one lattice cell, having lattice nodes and lattice connecting elements connected to the lattice nodes, the lattice cell also having a gyrating mass which is connected to the lattice nodes by at least one arm, the gyrating mass being designed to receive mechanical energy when the structure is in use. A lattice constant of the lattice cell has a dimension of less than 100 mm.

### CROSS REFERENCE TO RELATED APPLICATIONS

This application is the US National Stage of International Application No. PCT/EP2018/071334 filed 7 Aug. 2018, and claims the benefit thereof. The International Application claims the benefit of German Application No. DE 10 2017 214 060.7 filed 11 Aug. 2017. All of the applications are incorporated by reference herein in their entirety.

### FIELD OF INVENTION

The present invention relates to a functional structure, e.g. a structure for an energy converter or a damping structure, and to a component for a turbomachine, and to a turbine.

The cited component or the component part is provided for use in a turbomachine, such as in the hot gas path of a gas turbine, for example. The component part is advantageously composed of a high-temperature material or of a superalloy, in particular a nickel- or cobalt-based superalloy. The alloy may be precipitation-hardened or precipitation-hardenable.

The functional structure or component can be and/or is advantageously produced by means of a generative or additive production method. Additive methods comprise selective laser melting (SLM) or laser sintering (SLS) or electron beam melting (EBM) as powder bed methods, for example. Laser metal deposition (LMD) also belongs to the additive methods.

### BACKGROUND OF INVENTION

One method for selective laser melting is known from EP 2 601 006 B1, for example.

A component part with damping functionality and a method for the additive buildup of the component part are furthermore described in DE 102010063725.

Additive manufacturing methods have proven particularly advantageous for complex component parts or component parts of complicated or delicate design, e.g. labyrinth-type structures, cooling structures and/or lightweight structures. Additive manufacture is advantageous especially because of a particularly short series of process steps since a production or manufacturing step for a component part can take place directly on the basis of a corresponding CAD file.

Particularly in rotating machines, e.g. turbomachines, there is vibration or oscillation, which reduces the life of the components of these machines. In the case of turbomachines, these oscillations arise, for example, during the operation of a corresponding turbine owing to the rotation of the rotor components. These oscillations can furthermore lead to the initiation of cracks or even to the failure of the component part. This, in turn, can cause consequential damage to the entire turbomachine. Oscillations can arise, for example, in the gas path of a turbine independently of rotating components, and these disrupt the optimum flow profile and can thus lead to damage to component parts. The integration of (oscillation-) damping structures can reduce these vibrations and oscillations and ideally even compensate for them.

SUMMARY OF INVENTION

It is therefore an object of the present invention to specify means which allow intelligent oscillation or vibration damping or even compensation of oscillations. Advantageous energy storage can furthermore be made possible by the means described.

This object is achieved by the subject matter of the independent patent claims. Advantageous embodiments form the subject matter of the dependent patent claims.

One aspect of the present invention relates to a functional structure, e.g. for use in an energy converter, in particular a turbomachine, such as a gas turbine. The structure comprises a lattice having at least one lattice cell. The lattice cell for example refers to an elementary cell, in particular a cell which has a cubic, cube-shaped, rhombohedral or hexagonal geometry. The lattice cell advantageously comprises lattice nodes and lattice connecting elements connected to the lattice nodes, wherein the lattice cell furthermore has a gyrating mass, advantageously within the lattice cell, which is connected to a lattice node by means of at least one arm. When the structure is in use, the gyrating mass is expediently connected to the arm and is designed to absorb energy, e.g. mechanical energy, wherein a lattice constant or a length or height of the lattice or elementary cell advantageously has a dimension of less than 100 mm. These size ratios or geometries are particularly expedient in terms of suitability for production by additive methods.

The cited gyrating mass and the arm - which is likewise a lattice connecting element for example, advantageously forms an oscillatory system together with the rest of the lattice or the lattice cell.

In the present case, the functional structure is advantageously produced by an additive production method. The geometric degrees of freedom offered by additive production, in particular selective laser melting, can be exploited in a particularly expedient way for the invention described and, in particular, the gyrating mass together with the arm can be configured for the damping or energy storage application described.

The arm can be of structurally similar design to the lattice connecting elements.

In the case where the functional structure is used as a damping element, the gyrating mass is deflected or moved relative to the lattice cell, advantageously elastically, by a vibration or oscillations, as a result of which (mechanical) oscillation energy is absorbed or received. This would advantageously lead to damping of the entire component, such as a turbine blade, having the functional structure.

In the case of an energy storage device, the functionality is similar, and the gyrating mass likewise absorbs energy, which can be released again or converted by suitable means at some later point in time, for example.

In one embodiment, the geometry of the arm and/or of the gyrating mass are/is matched to the intended use of the structure. For example, the material and/or the mass of the gyrating mass and/or a corresponding mass distribution thereof can be matched to the intended use of the component or of the structure. A geometry or length which determines the oscillation modes or resonant frequencies of the arm (including the gyrating mass), for example, can furthermore advantageously be selected in accordance with the intended use. For example, a thickness of the arm and/or a geometry of the gyrating mass can be selected in a particularly simple manner or even made possible for the first time by means of an additive manufacturing method.

In one embodiment, the structure has a multiplicity of lattice cells which are similar, e.g. geometrically similar, or of the same type. By virtue of this multiplicity or plurality of functional structures or lattice cells arranged adjacent to one another on the corresponding component, for example, there is the preferential possibility of retaining the geometry of the component while nevertheless achieving an efficient damping effect.

In one embodiment, the arm has a predetermined breaking point, which breaks or is activated under a mechanical load which is excessive in relation to the intended operation of the structure, e.g. vibrations or oscillations, and thus allows an emergency function of the component having the structure. In the case of a component used in the hot gas path or the rotor of a gas turbine, for example, a predetermined breaking point of this kind can allow an emergency running functionality of the turbine, with the result that the corresponding rotor or blade component still allows at least destruction-free rundown of the turbine, rather than complete destruction.

In one embodiment, the gyrating mass is designed to absorb dynamic energy, in particular vibration or oscillation energy, when the structure is in use.

In one embodiment, the structure is provided for use in a turbomachine, for example in a rotating part of a gas turbine.

In one embodiment, the structure is designed for use as an energy storage device and/or for energy conversion.

Another aspect of the present invention relates to a method for additive production of the functional structure.

Another aspect of the present invention relates to a component for a turbomachine, such as a gas turbine, comprising the functional structure.

In one embodiment, the component rotates in use as intended.

In one embodiment, the component is designed for use in the hot gas path of a gas turbine. According to this embodiment, the component is advantageously manufactured from a high-temperature material and/or from a nickel- or cobalt-based superalloy.

In one embodiment, the component is a turbine blade.

Another aspect of the present invention relates to a turbine comprising the functional structure and/or the component.

Embodiments, features and/or advantages which relate to the structure in the present case may furthermore relate to the component or vice versa.

### BRIEF DESCRIPTION OF THE DRAWINGS

Further details of the invention are described below with reference to the figures.

FIG. 1 shows a schematic perspective view of a functional structure.

FIG. 2 shows an illustrative component comprising the structure from FIG. 1.

### DETAILED DESCRIPTION OF INVENTION

In the illustrative embodiments and figures, those elements which are the same or have the same effects may each be provided with the same reference signs. The illustrated elements and the size ratios thereof should fundamentally not be regarded as true to scale; on the contrary, individual elements may be illustrated as being of exaggeratedly thick or large dimensions for greater clarity of illustration and/or better understanding.

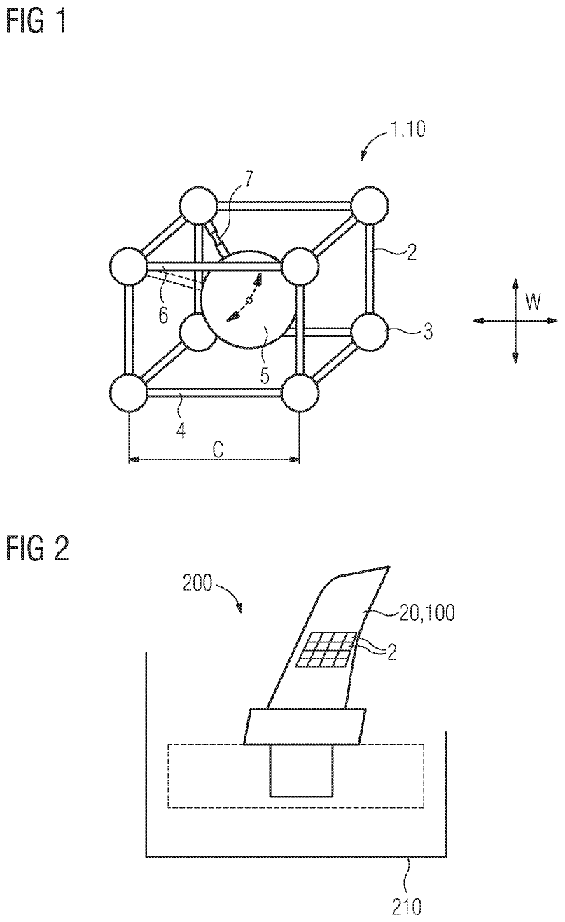

FIG. 1 shows a functional structure 1 by way of example. The functional structure 1 can be or comprise an energy storage device 10 for storing energy, e.g. mechanical energy, or for converting or transforming mechanical energy.

The structure 1 comprises at least one lattice cell 2. The lattice cell 2 advantageously forms a cubic, rhombohedral, hexagonal, cuboidal or cube-shaped elementary cell or lattice cell. The lattice cell 2 comprises lattice nodes 3. The lattice cell 2 furthermore comprises lattice connecting elements 4 connecting the lattice nodes 3. In accordance with the cubic or cube-shaped cell geometry shown, the lattice cell 2 advantageously has eight lattice nodes 3 and twelve lattice connecting elements 4 connecting the lattice nodes in a regular arrangement.

The lattice cell 2 or structure 1 furthermore has a gyrating mass 5. The gyrating mass 5 is connected to at least one of the lattice connecting elements 3 by an arm 6 (cf. the arm shown in solid lines). Instead of just one arm, the gyrating mass 5 can be connected to a lattice node 3 by at least one further arm 6 (cf. the arm illustrated in broken lines). By means of the number of arms or the thickness or length of the arms 6, an oscillation frequency, excitation frequency or natural frequency of the oscillatory gyrating mass 5 can be set, for example. Variation of the elasticity modulus of the arm and/or of the mass or density of the gyrating mass 5 as a parameter can have the same effect.

In the case of an external oscillation or rotation (indicated by an arrow cross in FIG. 1) which is undergone by the structure 1, e.g. during the operation of a component 100 having the functional structure 1 (cf. FIG. 2), the gyrating mass 5 advantageously stores mechanical oscillation or vibration energy W by being deflected, mechanically moved or rotated relative to the rest of the lattice cell 2. It is thereby advantageously possible to prevent destruction of the entire component.

The lattice cell 2 can have a lattice constant C or edge length of the lattice connecting elements 4 of at most 100 mm, for example (in the case of a cubic lattice geometry). For example, the cited lattice constant C can be 50 mm, advantageously 10 mm or less, e.g. 5 mm or 1 mm or at least 0.5 mm.

The functional structure 1 as shown in FIG. 1 can be an energy converter, which converts mechanical oscillation or vibration energy, for example, acting on the structure 1 from the outside, into kinetic and/or mechanical (oscillation or vibration energy) of the gyrating mass 5. Depending on the embodiment of the oscillatory system comprising the arm 6 and the gyrating mass 5, the functional structure 1 may be used in some circumstances to form an energy storage device, e.g. if the oscillation energy of the gyrating mass 5 is converted back into some other form of energy, e.g. heat, at a later point in time.

By way of example, FIG. 2 shows a schematic side view of a turbine 200 having a component 100 or turbine blade 20. The turbine blade 20 has an airfoil (not designated explicitly). The airfoil has a multiplicity of functional structures—similar to the functional structure described individually in FIG. 1—as a damping structure. The damping structures 1 or lattice cells 2 which the turbine blade 20 in FIG. 2 has can in particular be designed to be of the same type, to be similar and/or, alternatively, to be dimensioned or assembled differently in respect of their natural frequencies. Particularly the variable configuration of such damping structures is possible in a simple manner by virtue of the additive manufacture, in particular selective laser melting. For example, the natural frequencies of the damping structure shown in FIG. 2 can be graduated, i.e. each individual functional lattice cell 2 of the structure 1 can have a different natural frequency and thus absorption capacity for mechanical, in particular dynamic, loads or energies. As a result, the bandwidth for the absorption of mechanical energy and thus potentially destruction tolerance of the turbine blade 20 is advantageously particularly large.

Moreover, the turbine blade 20 has a blade root, via which the turbine blade is connected, for example, to a rotor or a rotor disk (not designated explicitly) of the turbine 200.

In a profile view of the turbine blade 20, the functional structure 1 comprising a multiplicity of lattice cells 2 can furthermore be arranged circumferentially, thereby making it possible to adapt an absorption capacity for dynamic external influences to a mass profile of the component (in cross section), for example.

As an alternative to the turbine blade 20 shown by way of example, it is possible for generally rotating parts or any oscillation- or vibration-generating components to be intended.

The invention is not restricted to the illustrative embodiments by the description with reference to these but includes each novel feature and any combination of features. In particular, this includes any combination of features in the patent claims, even if this feature or this combination is itself not explicitly cited in the patent claims or illustrative embodiments.

1. A functional structure for use in an energy converter, the structure comprising:
a lattice having at least one lattice cell, comprising lattice nodes and lattice connecting elements connected to the lattice nodes, wherein the lattice cell furthermore has a gyrating mass, which is connected to a lattice node by means of at least one arm,
wherein the gyrating mass is designed to absorb energy when the structure is in use, and
wherein a lattice constant of the lattice cell has a dimension of less than 100 mm.

2. The structure as claimed in claim 1,
wherein a geometry of the arm and of the gyrating mass are matched to the intended use of the structure.

3. The structure as claimed in claim 1,
wherein the structure has a multiplicity of lattice cells which are similar or of the same type.

4. The structure as claimed in claim 1,
wherein the arm has a predetermined breaking point, which breaks under a mechanical load which is excessive in relation to the intended operation of the structure and thus allows an emergency function of a component having the structure.

5. The structure as claimed in claim 1,
wherein the gyrating mass is designed to absorb dynamic energy, vibration or oscillation energy, when the structure is in use.

6. The structureas claimed in claim 1,
which is provided for use in a turbomachine, or in a rotating part of a gas turbine.

7. The structure as claimed in claim 1,
which is designed for use as an energy storage device and/or for energy conversion.

8. A component for a turbomachine or a gas turbine, comprising:
a functional structure as claimed in claim 1.

9. The component as claimed in claim 8,
which rotates while being used as intended and is designed for use in a hot gas path of a gas turbine.

10. The component as claimed in claim 9, which is a turbine blade.

11. A turbine comprising:
a functional structure as claimed in claim 1.
